(19) United States
(12) Patent Application Publication
(10) Pub. No.: US 2016/0352060 A1
(43) Pub. Date: Dec. 1, 2016

(54) Tunable Optical Filter and Tunable Light Source

(71) Applicants: Pin Long, Montreal (CA); Mohammad Abtahi, Montreal (CA)

(72) Inventors: Pin Long, Montreal (CA); Mohammad Abtahi, Montreal (CA)

(21) Appl. No.: 14/724,920

(22) Filed: May 29, 2015

(51) Int. Cl. H01S 3/00; G02B 27/30; G02B 26/00

(52) U.S. Cl. CPC H01S 3/0078; G02B 26/007; G02B 27/30

(57) ABSTRACT

A tunable filter structure comprising of a rotating disk made of metal parts in which N diffractive elements like bulk gratings are adjusted and mounted individually to disperse the incoming light and form a Littman-Metcalf configuration for selecting different wavelength of light, a servo motor to rotate the disk, a reflective element like mirror and a multi-branch configuration comprising of M branches that are synchronized in time and are combined by an optical coupler or an optical switch. In the second embodiment, the diffractive elements are replaced by the reflective elements to form a Littrow configuration. The tunable filter can be used in combination of a gain medium like semiconductor optical amplifier (SOA) or an Erbium-doped fiber amplifier (EDFA), in a ring or linear configuration to make a sweeping light source with low cost and high sweeping frequency.

### BACKGROUND OF INVENTION

Wavelength-swept lasers have long been considered as S optical sources in several applications including: coherence tomography (biomedical imaging), optical reflectometry, sensor interrogation, and test and measurement. In biomedical applications for optical frequency-domain imaging, a high repetition rate of tuning is highly desirable since the sweep rate determines the imaging speed [1, 2]. A key component in these techniques is the light source; this must be stable, widely tunable for high spatial resolution, operate at high sweep speeds and at the same time be available at a low-cost.

In all available approaches a broadband amplified spontaneous emission (ASE) source is connected to a tunable filter in a ring or linear structure. Two wavelength tuning schemes have been demonstrated, the fiber Fabry-Perot tunable filter (FFP-TF) and the polygon mirror configuration. The first setup uses piezoelectric actuated FFP-TF to produce sinusoidal, bidirectional wavelength sweeps. The bidirectional sweeps are not suitable for some applications. In the second configuration, a polygon mirror changes the incident angle of light to a dispersive element like a grating to generate linear wavelength sweeps [3-7]. The high speed rotating mirror can be a galvanometer or a rotating polygon mirror.

Both galvanometer and polygon configurations suffer from the extremely high cost. The galvanometers use a moving magnet torque motor technology besides an accelerator to oscillate a single mirror forward and backward with a few million radians per second. Besides the high cost, the galvanometers provide a bidirectional sweeping. In rotating polygon configuration, a polygon shape metal piece (normally aluminum) is fabricated with very precise angles and polished and coated for a mirror finish [3]. The fabrication cost of polygons in addition to use of high speed motors makes the polygons still expensive for many applications.

In the present invention we represent a tunable filter structure using a disk in which diffractive elements (gratings) are adjusted and mounted individually to disperse the incoming light into different colors for the purpose of selecting wavelength, a servo motor to rotate the disk, and a reflective element. In the proposed structure the light passes two times through the diffractive elements, which provides narrower bandwidth compared to the polygon mirrors. A narrower light source provides higher resolution images in tomography applications. Furthermore, we use a multi-branch configuration. This configuration simply multiplies the sweeping frequency without increasing the number of diffractive elements or using the higher speed motors.

The tunable optical filter can be used in a linear or ring fiber laser structure which consists of a gain medium (like EDFA or SOA), a circulator in case the tunable filter is a reflection type, one or more polarization controllers and a fiber coupler to let part of light into output port.

### SUMMARY OF THE INVENTION

In view of the problems described above including the high cost for polygon mirrors, it is an object of the present invention to provide a low-cost tunable filter which achieves the high speed and narrower bandwidth.

According to the present invention, the tunable optical filter of a sweeping light source comprises: a rotating disk which is rotated by a regular low-cost commercially available servo motor (or similar motors like stepper motor); N diffractive elements like diffraction gratings which are adjusted and mounted individually on the disk to diffract the light from a collimator to a reflective element like a mirror. In a multi-pass configuration, M collimators and reflective elements are installed in front of the rotating disk with the precise angle and distance to increase the sweeping frequency by a factor of M. In each time interval, only one out of M multi-passes is used to feedback the filtered light to the gain medium. The total sweeping frequency in Hz is SF=N×M×S/60 where, S is the rotation speed of the motor in rpm. By using a typical 10,000 rpm servo motor with 60 reflective elements and 2-pass structure, 20 KHz sweeping frequency with 120 nm wavelength tuning span can be achieved. If a tuning span of 80 nm is chosen, the number of multi-pass can be increased to 3 and the sweeping frequency will be 30 KHz while the number of diffractive elements and the motor speed remain constant. This high sweeping frequency is achieved by applying the proposed techniques in this invention using the ordinary low cost components.

In another embodiment, the diffractive elements on the disk are replaced by the reflective elements, resulting in a wider filter bandwidth but still lower cost due to the fabrication techniques and multi-pass configuration which are proposed in this invention.

### BRIEF DESCRIPTION OF THE DRAWINGS

For a better understanding of the present invention, reference is made to the following detailed description and the attached figures, where:

FIG. 1 is a schematic diagram of the tunable optical filter according to a first embodiment of the present invention.

FIG. 2 is a schematic diagram of the tunable optical filter according to the second embodiment of the present invention.

FIG. 3 is a view showing the tunable filter in a multi-pass configuration filter according to a first embodiment of the present invention.

FIG. 4 is a view showing the time-domain output signal of the sweeping laser source for each multi-pass branch and their combination filter according to the present invention.

FIG. 5 is a view showing the loop and linear structure of laser source (Prior Art), according to the present invention.

FIG. 6 is a similar view of the first and second embodiments in which a gains chip is imposed directly in front of the rotating disk, according to the present invention.

### DETAILED DESCRIPTION OF THE PREFERRED EMBODIMENTS

With reference to the annexed drawings the preferred embodiment of the present invention will be herein described for indicative purpose and by no means as of limitation.

### 1. First Embodiment

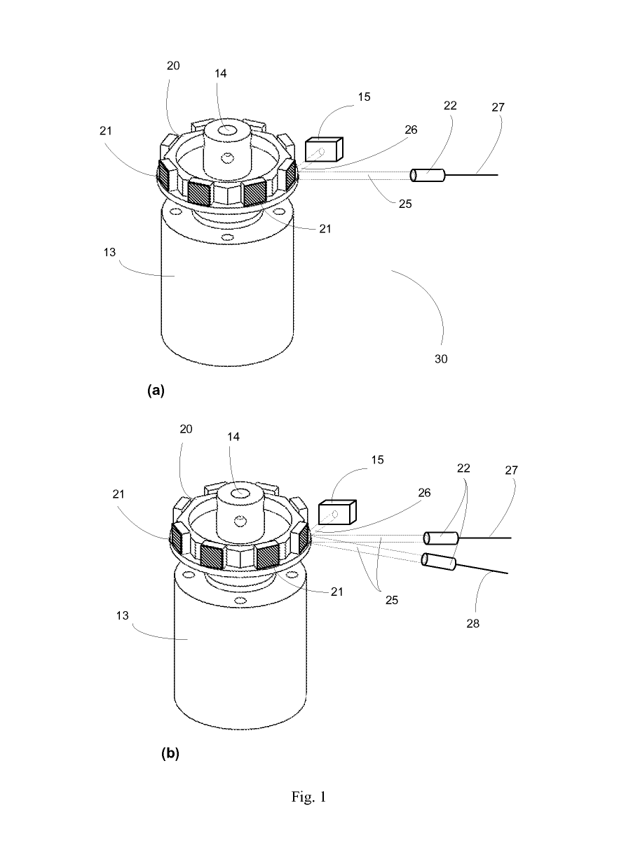

Referring to FIG. 1(a), there is shown an embodiment of the low-cost tunable filter which consists of a metal rotating disk (20), a motor (13), a number of diffractive element for example diffraction bulk gratings (21), a reflective element like mirror (21) and an optical collimator (22). The rotating disk 20 could be made of aluminum or stainless steel. It is fixed on the shaft 14 of the motor 13 (servo or stepper motor) using some screws. The diffractive elements 15 will be adjusted and mounted individually on the rotating disk 20. The radius of rotating disk 20 is determined by the size and the total number of diffractive elements 15. They are mounted on the disk 20 in equal separation space using epoxy. Each grating is adjusted individually in both horizontal and vertical directions. The reflective element could be simply a pre-cut mirror.

An optical fiber 27 which could be single-mode fiber (SMF) or polarization maintain fiber (PMF) or any other types of optical fiber is connected to a collimator 22 and is placed in a distance L1 (25) from the diffractive element 21 of the rotating disk 20. A reflective element for example a mirror (15) is placed in a distance L2 (26) of the diffractive element 21. The incoming light from fiber 27 is diffracted from diffractive element 21 to the mirror (15). The angle of gratings (21) and mirror are chosen in such a manner to form a Littman-Metcalf configuration. The light then reflects back from the mirror to the grating (21) and focus to the same collimator (22) and the same fiber (27). The combination of optical fiber 27, collimator 22 and the diffractive element 21 and reflective element 15 forms a single-branch filter 30.

In contrast with polygon mirrors, here the diffractive elements are installed on the rotating disk which enables us to form a Littman-Metcalf configuration. This configuration makes the optical filter much narrower and results in a shorter laser bandwidth when the filter is used to make a tunable laser source.

In the second form of the first embodiment shown in FIG. 1(b), the diffracted light from grating (21) is reflects back to another collimator and focused in the fiber (28). So the fiber 27 is the input and the fiber 28 is the output of the tunable filter. This structure helps us to remove the circulator from the fiber laser loop structure.

### 2. Second Embodiment

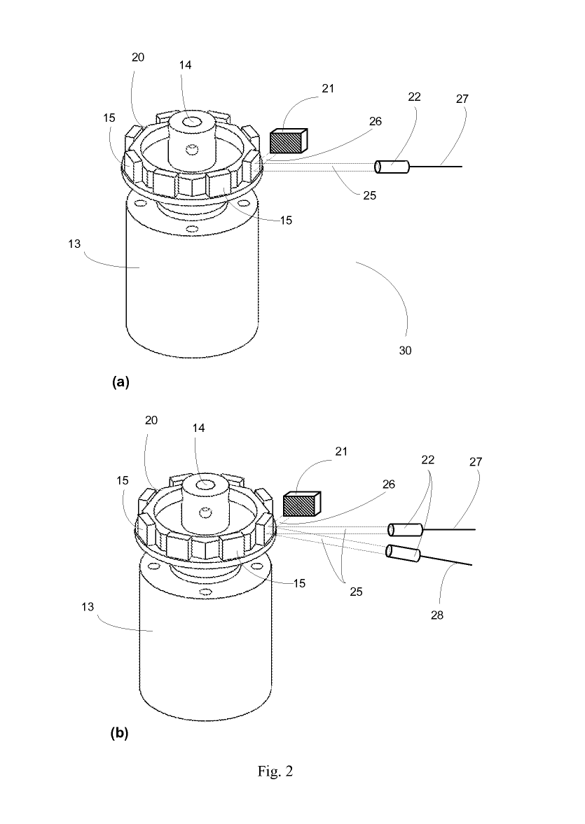

Referring to FIG. 2(a), there is shown the second embodiment of the low-cost tunable filter which consists of a metal rotating disk (20), a motor (13), a number of reflective elements (15), a diffraction bulk grating (21) and an optical collimator (22).

This embodiment is generally similar to the first embodiment except that the reflective elements (15) are mounted on the rotating disk while a single diffractive element (21) is used to diffract back the light to mirrors in a Littrow configuration.

Like before, each reflective element is adjusted individually in both horizontal and vertical directions. This embodiment provides a wider bandwidth filter compared to the first embodiment. However, in contrast with polygon, the rotating disk 20 does not need to be made with precision angles and highly polished surfaces which reduced dramatically the fabrication cost.

In the second form of the first embodiment shown in FIG. 2(b), the diffracted light from grating (21) is reflects back to another collimator and focused in the fiber (28). So the fiber 27 is the input and the fiber 28 is the output of the tunable filter. This structure helps us to remove the circulator from the fiber laser loop structure.

From now on throughout this application we use the first embodiment in FIG. 1(a) only for simplicity and by no means as of limitation. The following inventive concepts can be applied to the 2^{nd} embodiment too.

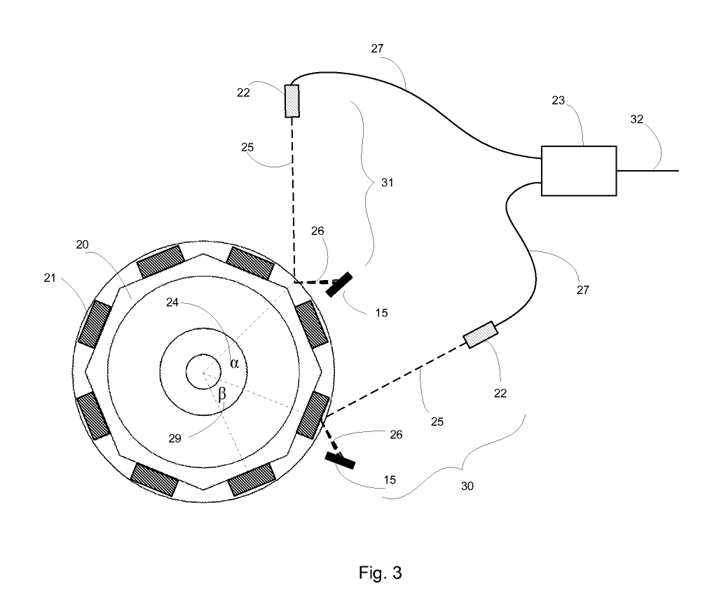

Referring now to FIG. 3 where the concept of multi-branch configuration is illustrated. The angle between two consecutive diffractive elements 21 in the rotating disk 20 is β (29) and is chosen in such a manner that the total number of diffractive elements be an integer: N=2π/β.

We focus on the first embodiment using a single collimator (refer to FIG. 1(a)). Similar to the first branch 30, a second branch 31 is installed in the same way in front of rotating disk (20) in FIG. 3 to make a multi-branch configuration. In general M-branch filters can be installed. The optical fibers 27 from all branches are combined in a combiner 23 which could be simply a coupler or an M×1 optical switch. In each time interval only the light from a single optical fiber 27 is connected to the output fiber 32. The optical switch 23 should be synchronized with the rotating disk 20.

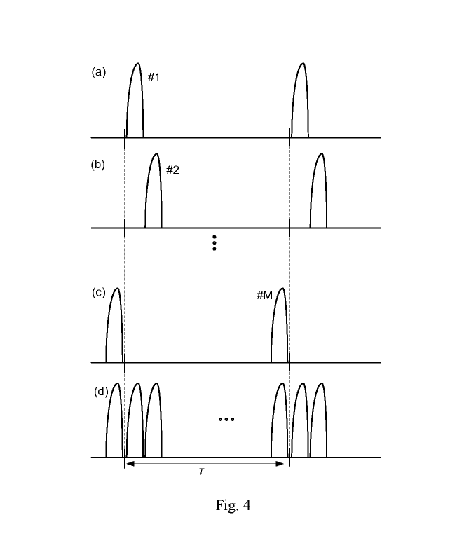

FIG. 4(a) shows the output power of sweeping light source in time domain due to a single branch, where T is the time interval between passing the two consecutive reflective elements. T is determined by the rotational speed of the motor and the physical distances between two consecutive reflective elements. Part (b) and (c) in FIG. 4, show the same for the 2^{nd} and /M^{th} branches. The combination signal of all branches after the combiner 23 is shown in FIG. 4(d). The sweeping frequency is now multiplied by a factor of M. The angle between each two consecutive branches α (24 in FIG. 3) should be chosen correctly to prevent any overlap between signals. For M-branch configuration, the angle α (24) is defined by α=nβ+β/M, where n is an integer. The number of branches M depends also on the tuning span of the sweeping light source.

The wider tuning span, the wider pulses in FIG. 4, which in turn reduces the maximum number of branches: max(M)=2π/N/Δθ=β/Δθ, where Δθ is the rotation angle of reflective element corresponding to the tuning span. The total sweeping frequency in Hz is SF=N×M×S/60, where S is the rotation speed of motor in rpm.

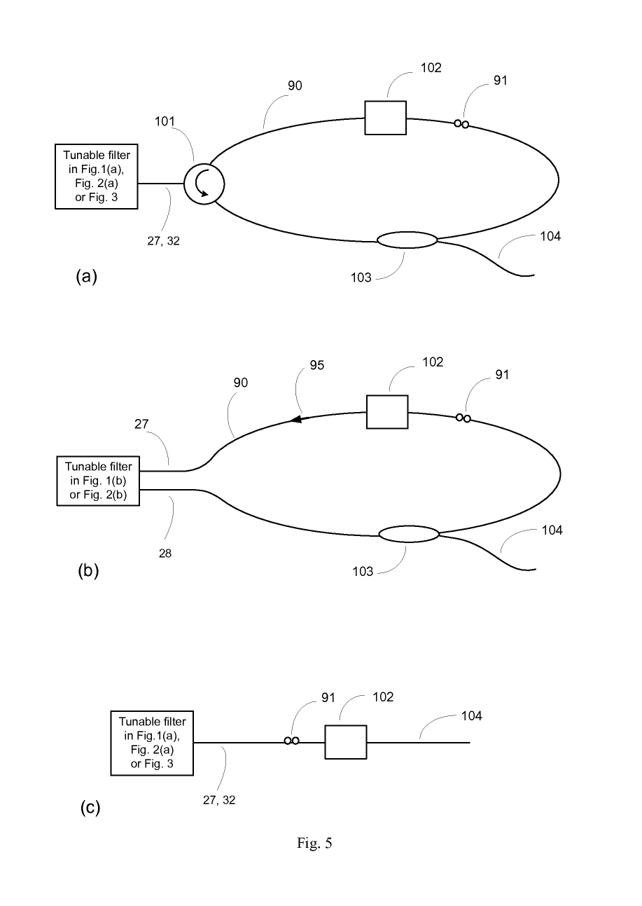

The new tunable filter in FIG. 1, FIG. 2, or the structure with multi-branch configuration (FIG. 3) in the present application can be used in the prior-art loop structure to make a standard ring structure tunable fiber laser as shown in FIG. 5. The optical fiber 27 in the tunable filter in FIG. 1(a), FIG. 2(a) or the optical fiber 32 in FIG. 3 is connected to a loop by circulator 101. It is connected to a gain medium 102 which could be an SOA or EDFA (102) using optical fiber 90 and polarization controller 91. The coupler 103 takes part of laser power out to the optical fiber 104. The polarization controller 91 adjusts the light polarization for the best performance.

FIG. 5(b) shows another loop structure in which the circulator 103 is removed. In this case, the tunable filter with two collimators (FIG. 1b, or FIG. 2b) is used. An isolator (95) is added in the loop to control the direction of light propagation in the fiber laser.

A standard linear structure tunable fiber laser is shown in FIG. 5(c). In this case, tunable filter in FIG. 1(a), FIG. 2(a) or FIG. 3 is connected to gain medium 102 and the output laser is taken from fiber 104. The polarization controller 91 adjusts the light polarization for the best performance.

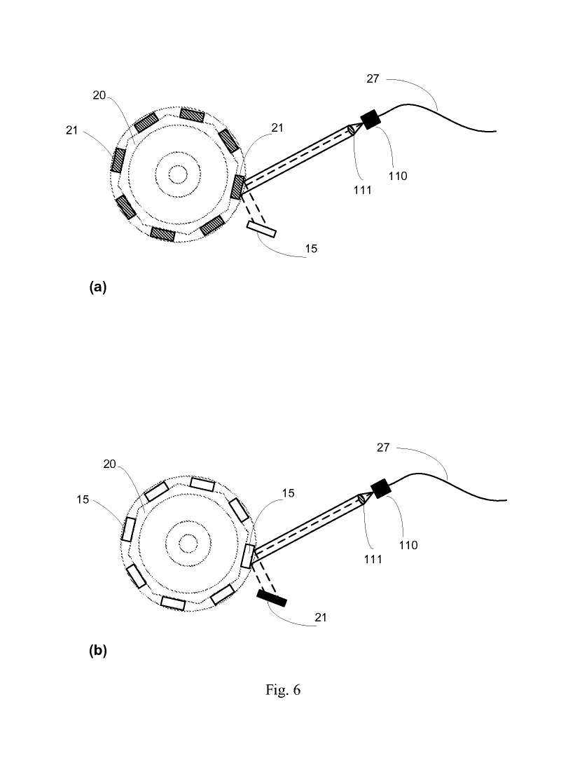

FIG. 6 shows the same embodiments as in FIG. 1 and FIG. 2, in which the collimator is replaced by a gain chip 110. The light of gain chip is collimated using a lens 111 to the diffractive element 21 of the rotating disk 20 in FIG. 6(a). The light is then diffracted back from the reflective element 15 and focused again to the gain chip. By rotating the disk 20, the center wavelength can be tuned in the same way as in the previous embodiment. FIG. 6(b) shows the 2^{nd} embodiment version using the gain chip. Here again, the reflective elements 15 are mounted on the rotating 20 disk while a single diffractive element is used. A multi-branch configuration can also be used to combine the tunable sweeping light sources with the same or different center wavelengths.

What is claimed is:

1. A tunable optical filter comprising:
a simple, low-cost rotating disk;
N diffractive elements (gratings) which are aligned and mounted individually on the said rotating disk;
a servo motor or a stepper motor to rotate the said rotating disk;
a collimator to incident the input light on the said diffractive elements and to get back the reflected light;
a reflective element (mirror) to reflect back the diffracted light from the grating;

2. A fabrication technique for the said tunable optical filter in claim 1 in which the optical components are adjusted and mounted individually on the said rotating disk in order to achieve a low-cost optical filter.

3. A tunable optical filter as in claim 1, in which two collimators are used: one to incident the light on the said diffractive elements and the second one to get back the reflected light;

4. A tunable optical filter as in claim 1, in which a multi-branch configuration comprising of M branches that are synchronized in time and combined by an optical coupler or an optical switch is used, in order to increase the sweeping frequency by a factor of M.

5. A tunable optical filter as in claim 1, in which the said diffractive elements on the said rotating disks are replaced by the reflective elements and the said reflective element is replaced by a diffractive element according to the second embodiment.

6. A tunable optical filter as in claim 5, in which two collimators are used: one to incident the light on the said diffractive elements and the second one to get back the reflected light;

7. A tunable optical filter as in claim 5, in which a multi-branch configuration comprising of M branches that are synchronized in time and combined by an optical coupler or an optical switch is used, in order to increase the sweeping frequency by a factor of M.

8. A tunable sweeping laser source in a loop or linear configuration comprising:
said tunable optical filter in claim 1 and a gain medium like SOA or EDFA;

9. A tunable sweeping laser source in which the said collimator in the said tunable filter according to claim 1 is replaced by a gain chip.
